(19) United States
(12) Patent Application Publication
(10) Pub. No.: US 2012/0304654 A1
(43) Pub. Date: Dec. 6, 2012

(54) COMBUSTION LINER HAVING TURBULATORS

(76) Inventors: Patrick Benedict Melton, Horse Shoe, NC (US); David William Cihlar, Greenville, SC (US); David Kaylor Toronto, Greenville, SC (US)

(21) Appl. No.: 13/153,778

(22) Filed: Jun. 6, 2011

(51) Int. Cl. F02C 7/22

(52) U.S. Cl. 60/746

(57) ABSTRACT

A combustor for a turbine is provided. The combustor includes a plurality of fuel nozzles and a combustion zone is aligned with a combustion process associated with each of the fuel nozzles. A combustion liner includes a plurality of turbulator groups, and each of the turbulator groups has or more individual turbulators. Each of the turbulator groups is aligned with a hot streak caused by the combustion zone associated with the fuel nozzle. Each of the turbulator groups are circumferentially spaced from a neighboring turbulator group.

### BACKGROUND OF THE INVENTION

This invention relates to internal cooling within a gas turbine; and more particularly, to an apparatus for providing better and more uniform cooling in a combustion liner of the turbine.

Traditional gas turbine combustors use diffusion (i.e., non-premixed) combustion in which fuel and air enter the combustion chamber separately. The process of mixing and burning produces flame temperatures exceeding 3900° F. Since conventional combustors and/or transition pieces having liners are generally capable of withstanding a maximum temperature on the order of only about 1500° F. for about ten thousand hours (10,000 hrs.), steps to protect the combustor and/or transition piece must be taken. This has typically been done by film-cooling which involves introducing relatively cool compressor air into a plenum formed by the combustor liner surrounding the outside of the combustor. In this prior arrangement, the air from the plenum passes through louvers in the combustor liner and then passes as a film over the inner surface of the liner, thereby maintaining combustor liner integrity.

Because diatomic nitrogen rapidly disassociates at temperatures exceeding about 3000° F. (about 1650° C.), the high temperatures of diffusion combustion result in relatively large NOx emissions. One approach to reducing NOx emissions has been to premix the maximum possible amount of compressor air with fuel. The resulting lean premixed combustion produces cooler flame temperatures and thus lower NOx emissions. Although lean premixed combustion is cooler than diffusion combustion, the flame temperature is still too hot for prior conventional combustor components to withstand.

Furthermore, because the advanced combustors premix the maximum possible amount of air with the fuel for NOx reduction, little or no cooling air is available, making film-cooling of the combustor liner and transition piece premature at best. Nevertheless, combustor liners require active cooling to maintain material temperatures below limits. In dry low NOx (DLN) emission systems, this cooling can only be supplied as cold side convection. Such cooling must be performed within the requirements of thermal gradients and pressure loss. Thus, means such as thermal barrier coatings in conjunction with “backside” cooling have been considered to protect the combustor liner and transition piece from destruction by such high heat. Backside cooling involved passing the compressor discharge air over the outer surface of the transition piece and combustor liner prior to premixing the air with the fuel.

With respect to the combustor liner, one current practice is to convectively cool the liner, or to provide continuous linear turbulators on the exterior surface of the liner. The continuous liner turbulators are evenly spaced and non-interrupted. The various known techniques enhance heat transfer but with undesirable effects on thermal gradients and pressure losses. Turbulators work by providing a blunt body in the flow which disrupts the flow creating shear layers and high turbulence to enhance heat transfer on the surface, but they also increase pressure drop which is undesirable.

A low heat transfer rate from the liner can lead to high liner surface temperatures and ultimately loss of strength. Several potential failure modes due to the high temperature of the liner include, but are not limited to, spallation of the thermal barrier coating, cracking of the aft sleeve weld line, bulging and triangulation. These mechanisms shorten the life of the liner, requiring replacement of the part prematurely.

Accordingly, there remains a need for enhanced levels of active cooling with minimal pressure losses at higher firing temperatures than previously available while extending a combustion inspection interval to decrease the cost to produce electricity.

### BRIEF DESCRIPTION OF THE INVENTION

According to one aspect of the present invention, a combustor for a turbine is provided. The combustor includes a plurality of fuel nozzles and a combustion zone is aligned with a combustion process associated with each of the fuel nozzles. A combustion liner includes a plurality of turbulator groups, and each of the turbulator groups has or more individual turbulators. Each of the turbulator groups is aligned with a hot streak caused by the combustion zone associated with the fuel nozzle. Each of the turbulator groups are circumferentially spaced from a neighboring turbulator group.

According to another aspect of the present invention, a combustor for a turbine is provided. The combustor has a plurality of fuel nozzles and a combustion zone is aligned with a combustion process associated with each of the fuel nozzles. A combustion liner includes a plurality of turbulator groups, and each of the turbulator groups has one or more individual turbulators. The turbulator groups are substantially aligned with a hot streak in the combustion liner caused by the combustion zone associated with the fuel nozzles. Each of the turbulator groups are circumferentially spaced from a neighboring turbulator group.

These and other features will become apparent from the following detailed description, which, when taken in conjunction with the annexed drawings, where like parts are designated by like reference characters throughout the drawings, and disclose embodiments.

### BRIEF DESCRIPTION OF THE DRAWINGS

FIG. 1 is a simplified side cross sectional illustration of a conventional combustor transition piece aft of the combustor liner;

FIG. 2 is a partial but more detailed perspective illustration of a conventional combustor liner and flow sleeve joined to the transition piece;

FIG. 3 illustrates the variation in metal temperatures of the combustion liner in a gas turbine;

FIG. 4 illustrates a simplified perspective view of a combustion liner, according to one aspect of the present invention;

FIG. 5 illustrates a partial cross-sectional view of a combustion liner having turbulators with variable axial spacing, according to another aspect of the present invention; and

FIG. 6 illustrates a partial cross-sectional view of a combustion liner having turbulators with variable axial spacing and height, according to another aspect of the present invention.

### DETAILED DESCRIPTION OF THE INVENTION

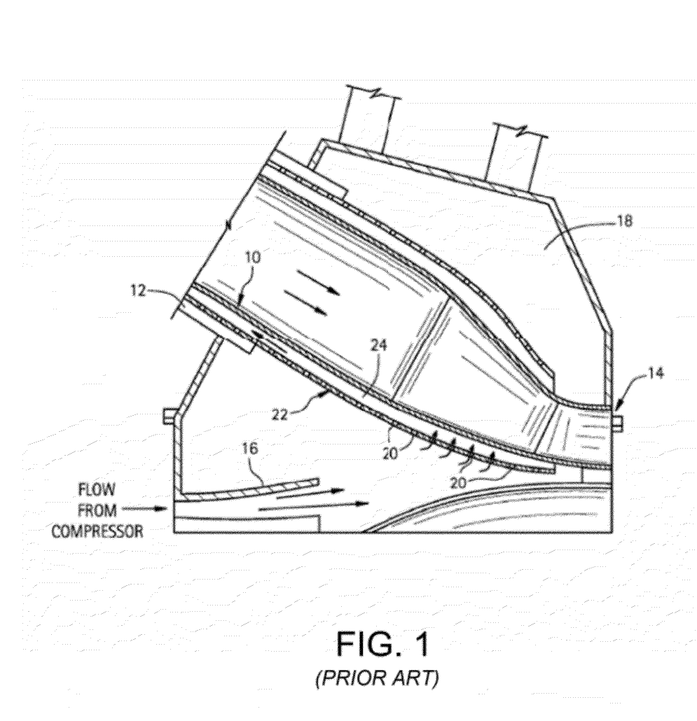

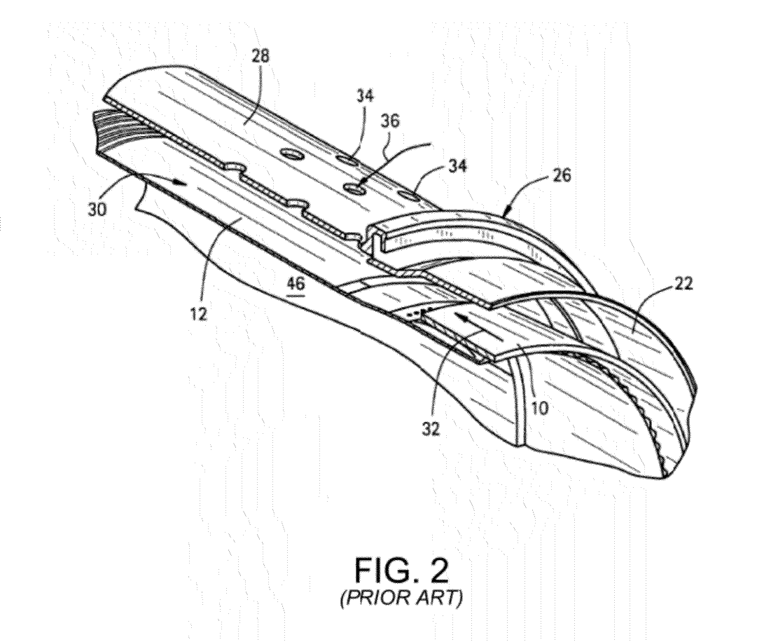

With reference to FIGS. 1 and 2, a typical gas turbine includes a transition piece 10 by which the hot combustion gases from an upstream combustor as represented by the combustion liner 12 are passed to the first stage of a turbine represented at 14. Flow from the gas turbine compressor exits an axial diffuser 16 and enters into a compressor discharge case 18. About 50% of the compressor discharge air passes through apertures 20 formed along and about a transition piece impingement sleeve 22 for flow in an annular region or annulus 24 (or, second flow annulus) between the transition piece 10 and the radially outer transition piece impingement sleeve 22. The remaining approximately 50% of the compressor discharge flow passes into flow sleeve holes 34 of an upstream combustion liner cooling sleeve (not shown) and into an annulus between the cooling sleeve and the liner and eventually mixes with the air in annulus 24. This combined air eventually mixes with the gas turbine fuel in a combustion chamber.

FIG. 2 illustrates the connection between the transition piece 10 and the combustor flow sleeve 28 as it would appear at the far left hand side of FIG. 1. Specifically, the impingement sleeve 22 (or second flow sleeve) of the transition piece 10 is received in a telescoping relationship in a mounting flange 26 on the aft end of the combustor flow sleeve 28 (or, first flow sleeve), and the transition piece 10 also receives the combustion liner 12 in a telescoping relationship. The combustor flow sleeve 28 surrounds the combustion liner 12 creating a flow annulus 30 (or, first flow annulus) therebetween. It can be seen from the flow arrow 32 in FIG. 2, that crossflow cooling air traveling in the annulus 24 continues to flow into the annulus 30 in a direction perpendicular to impingement cooling air flowing through the cooling holes 34 (see flow arrow 36) formed about the circumference of the flow sleeve 28 (while three rows are shown in FIG. 2, the flow sleeve may have any number of rows of such holes).

Still referring to FIGS. 1 and 2, a typical can annular reverse-flow combustor is shown that is driven by the combustion gases from a fuel where a flowing medium with a high energy content, i.e., the combustion gases, produces a rotary motion as a result of being deflected by rings of blading mounted on a rotor. In operation, discharge air from the compressor (compressed to a pressure on the order of about 250 400 lb/in²) reverses direction as it passes over the outside of the combustion liners (one shown at 12) and again as it enters the combustion liner 12 enroute to the turbine (first stage indicated at 14). Compressed air and fuel are burned in the combustion chamber, producing gases with a temperature of between about 1500° F. and about 2800° F. These combustion gases flow at a high velocity into turbine section 14 via transition piece 10.

Hot gases from the combustion section in combustion liner 12 flow therefrom into section 16. There is a transition region indicated generally at 46 in FIG. 2 between these two sections. As previously noted, the hot gas temperatures at the aft end of section 12, the inlet portion of region 46, is on the order of about 2800° F. However, the liner metal temperature at the downstream, outlet portion of region 46 is generally on the order of 1400° F. to 1550° F. To help cool the liner to this lower metal temperature range, during passage of heated gases through region 46, liner 12 is provided through which cooling air is flowed. The cooling air serves to draw off heat from the liner and thereby significantly lower the liner metal temperature relative to that of the hot gases.

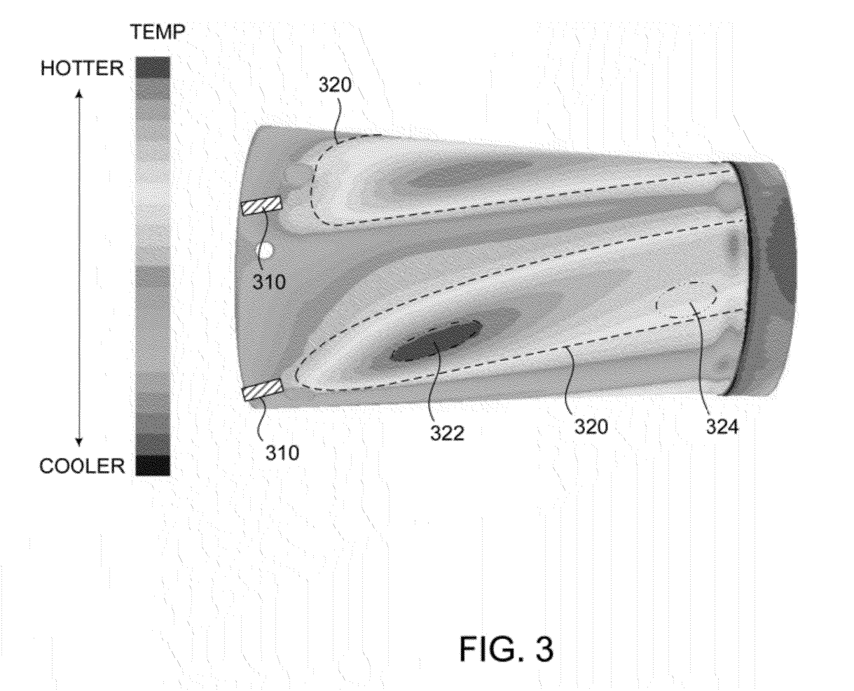

FIG. 3 represents one example of the metal temperatures of the combustion liner in a gas turbine. The flame nozzles 310 may be pointed in an offset direction, with respect to an axial direction of the combustion liner, to induce a swirl in the combustion gases. Alternatively, the flame nozzles may be directed substantially downstream but the vanes (not shown) in the nozzle induce an exiting swirl. The fuel nozzles and resulting combustion products generate temperature zones or hot streaks 320, as bounded by the dotted lines. A hot streak, in one example, is defined by a region having temperatures of between about 1,000° F. to about 1,800° F. These hot streaks are one example, and different configurations or alignments of fuel nozzles will produce different patterns or temperatures of hot streaks. The hot streaks 320 contain regions of hotter temperatures than in the regions between hot streaks, and these “in-between” regions are cooler than the hot streak regions 320. Further, each hot streak region 320 will contain sub-areas of varying temperatures. For example, area 322 is hotter than area 324. A hot streak 320 can be viewed as an elevated temperature zone caused by a combustion zone aligned with a combustion process associated with a fuel nozzle.

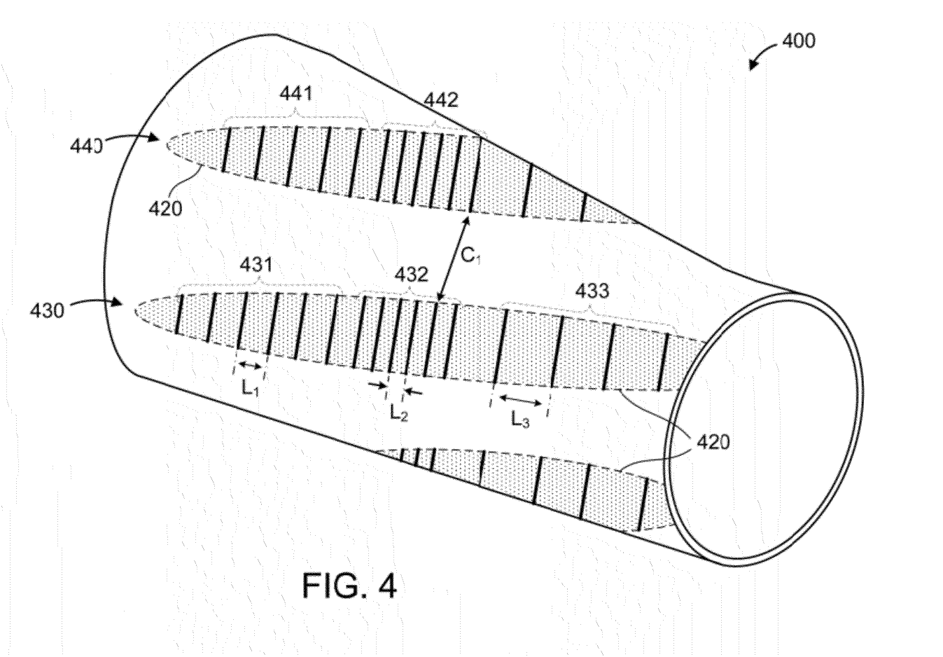

FIG. 4 illustrates a simplified perspective view of a combustion liner 400 having improved cooling and pressure drop characteristics, according to an aspect of the present invention. The combustion liner 400 includes a plurality of turbulators arranged in various groups where each group is aligned with the combustion zone or hot streak pattern of a fuel nozzle. Hot streak zones 420 are illustrated by the regions bounded by the dotted lines, but it is to be understood that the present invention can be applied to any combustion liner having any hot streak pattern.

The hot streaks 420 generally contain hotter temperatures than the surrounding regions not included in the hot streak regions (e.g., the regions between hot streaks 420). Further, each individual hot streak region will contain sub-regions or areas of various temperatures. Accordingly, an improved turbulator configuration is proposed to cool these hot streak regions more effectively while reducing pressure drop over the combustion liner 400.

A first group of turbulators 430 is aligned with a hot streak or combustion zone of a fuel nozzle, while a second group of turbulators 440 is aligned with another combustion zone (or hot streak) associated with a different fuel nozzle. Each individual turbulator may comprise a raised rib or raised portion having any desired shape for the specific application. The regions between the hot streaks do not have the turbulators 430, 440, and this feature reduces pressure drop in areas where turbulators are not required, and provides a more uniform circumferential temperature profile that reduces the global/overall liner stress. The first group of turbulators 430 may contain turbulators having variable axial spacing. For example, a turbulator sub-group 431 contains multiple turbulators having an axial spacing of L₁, a turbulator sub-group 432 contains multiple turbulators having an axial spacing of L₂, and a turbulator sub-group 433 contains multiple turbulators having an axial spacing of L₃. As shown, L3 is greater than L1, and L1 is greater than L2.

In this example, the hottest portion of the hot streak 420 is covered by the turbulator sub-group 432, a medium temperature portion of the hot streak is covered by the turbulator sub-group 431 and the coolest part of the hot streak is covered by turbulator sub-group 433. It can be seen that the turbulators may be configured to have the closest axial spacing in hotter regions, while cooler hot streak regions may have turbulators with a greater axial spacing. In addition, each group and/or sub-group of turbulators may be circumferentially spaced from a neighboring group of turbulators. For example, the first sub-group of turbulators 431 may be circumferentially spaced by a distance C1 from the second sub-group of turbulators 441. Each sub-group may also have substantially the same or a different circumferential spacing between a neighboring turbulator sub-group. Turbulator sub-group 441 may be spaced substantially the same or a different circumferential distance away from the sub-group turbulators 431, and sub-group turbulators 442 may be spaced the same or a different circumferential distance away from the sub-group turbulators 432. Further, each individual turbulator in a single subgroup may have variable axial spacing from adjacent individual turbulators in the same sub-group.

An advantage of this configuration is that the hottest regions of the hot streaks have greater cooling by the use of closely spaced turbulators, while cooler regions require less cooling and can employ turbulators having a greater axial spacing. Another advantage is that pressure drop is increased the most only in regions with the greatest cooling needs (e.g., the area covered by turbulators 432), and other areas have reduced pressure drop due to fewer turbulators or the presence of no turbulators (e.g., the regions between hot streaks 420).

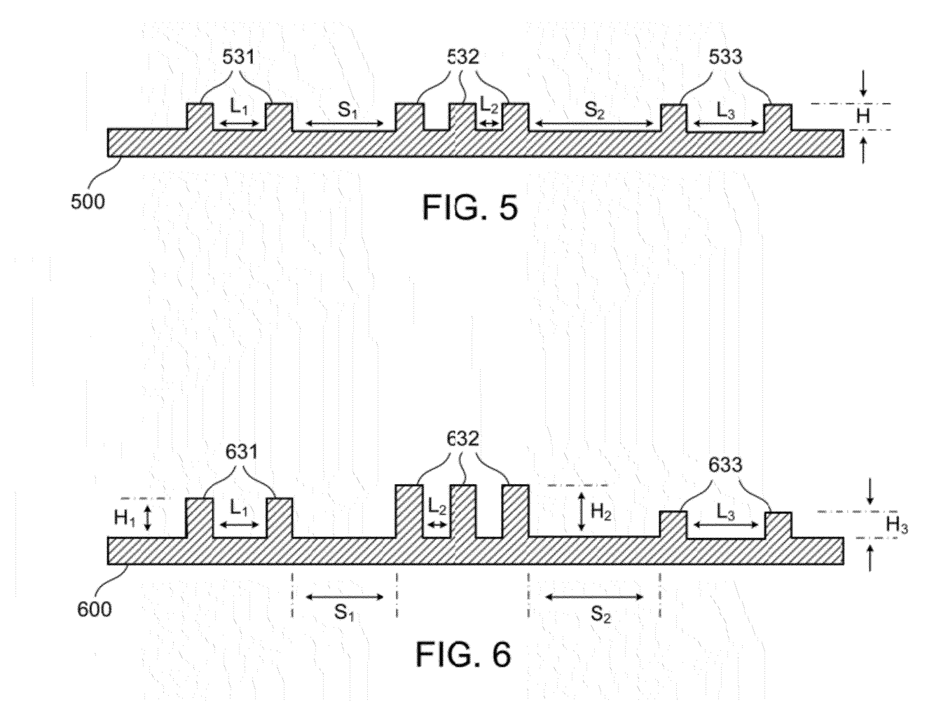

FIG. 5 illustrates a partial cross-sectional view of the combustion liner 500 having turbulators configured according to an aspect of the present invention. A first turbulator sub-group includes individual turbulators 531 having an inter-turbulator spacing of L₁. A second turbulator sub-group includes individual turbulators 532 having an inter-turbulator spacing of L₂. A third turbulator sub-group includes individual turbulators 533 having an inter-turbulator spacing of L₃. In this example, L₃ is greater than L₁, and L₁ is greater than L₂. It is to be understood that there can be one, two, three or more turbulator sub-groups in each group of turbulators associated with an individual hot streak area. All of the turbulators in this example have substantially the same height H. However, the axial spacing between turbulator sub-groups can vary, for example S2 is greater than S1.

The turbulators 532 may be located in the hottest or highest temperature portion of the hot streak, while the turbulators 533 may be located in a cooler or lower temperature portion of the hot streak. The turbulators 531 may be located in a portion of the hot streak having a temperature between the areas covered by turbulators 532 and 533. This configuration limits the maximum pressure drop to only those areas having the highest temperatures, and reduces the pressure drop for other areas of the hot streak and reduces the pressure drop even further for portions of the combustion liner outside the hot streaks.

FIG. 6 illustrates a partial cross-sectional view of the combustion liner 600 having turbulators configured according to another aspect of the present invention. A first turbulator sub-group includes individual turbulators 631 having an inter-turbulator spacing of L₁ and a height of H₁. A second turbulator sub-group includes individual turbulators 632 having an inter-turbulator spacing of L₂ and a height of H₂. A third turbulator sub-group includes individual turbulators 633 having an inter-turbulator spacing of L₃ and a height of H₃. In this example, L₃ is greater than L₁, and L₁ is greater than L₂, and H₂ is greater than H₁, and H₁ is greater than H₃. The spacing between turbulator sub-groups can vary, for example S2 is greater than S1.

The increased height H₂ of the turbulators 632 can help to further cool the hotter portions of the combustion liner in the hotter portions of the hot streak, by increasing turbulence to thereby increase heat transfer. In some applications or in some regions of the hot streak, it may be desirable to increase the height of at least some of the individual turbulators as well as the inter-turbulator axial spacing distance. In medium temperature regions, a medium height H₁ may be used, while in cooler regions of the hot streak a lower height H₃ may be used for inducing turbulence.

It can be seen that an increase in turbulation (and hence heat transfer) and a reduction in overall pressure drop can be obtained by circumferentially spacing groups of turbulators on a combustion liner in a gas turbine. A group of turbulators is substantially aligned with a hot streak associated with the combustion products of a fuel nozzle, and individual sub-groups of turbulators may have various heights and/or axial spacing between neighboring turbulators.

It is noted that the terms “first,” “second,” and the like, as well as “primary,” “secondary,” and the like, herein do not denote any amount, order, or importance, but rather are used to distinguish one element from another, and the terms “a” and “an” herein do not denote a limitation of quantity, but rather denote the presence of at least one of the referenced item. As used herein the term “about”, when used in conjunction with a number in a numerical range, is defined being as within one standard deviation of the number “about” modifies. The suffix “(s)” as used herein is intended to include both the singular and the plural of the term that it modifies, thereby including one or more of that term (e.g., the turbulator includes one or more turbulators).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A combustor for a turbine, the combustor having a plurality of fuel nozzles and a combustion zone aligned with a combustion process associated with each of the plurality of fuel nozzles, the combustor comprising:
a combustion liner comprising a plurality of turbulator groups, each of the plurality of turbulator groups comprising one or more individual turbulators, each of the plurality of turbulator groups aligned with a hot streak caused by the combustion zone associated with one of the plurality of fuel nozzles;
wherein each of the plurality of turbulator groups are circumferentially spaced from a neighboring turbulator group.

2. The combustor of claim 1, wherein an axial spacing between at least some of the individual turbulators in at least one of the plurality of turbulator groups is varied.

3. The combustor of claim 2, wherein the axial spacing between at least some of the individual turbulators is smaller in a hotter zone of the combustion liner, and the axial spacing between at least some of the individual turbulators is larger in a cooler zone of the combustion liner.

4. The combustor of claim 1, wherein each of the plurality of turbulator groups comprises multiple turbulator sub-groups.

5. The combustor of claim 4, wherein the multiple turbulator sub-groups further comprise:
at least one first turbulator sub-group having an axial spacing of L₁ between at least some adjacent individual turbulators, the at least one first turbulator sub-group located in a first portion of the combustion liner;
at least one second turbulator sub-group having an axial spacing of L₂ between at least some adjacent individual turbulators, the at least one second turbulator sub-group located in a second portion of the combustion liner;
wherein L₁ is greater than L₂, and the first portion is cooler than the second portion.

6. The combustor of claim 5, wherein at least some of the individual turbulators in the at least one first turbulator sub-group have a height of H₁, and at least some of the individual turbulators in the at least one second turbulator sub-group have a height of H₂, and wherein H₁ is less than H₂.

7. The combustor of claim 5, further comprising:
at least one third turbulator sub-group having an axial spacing of L₃ between at least some adjacent individual turbulators, the at least one third turbulator sub-group located in a third portion of the combustion liner,
wherein L₃ is greater than L₁, and L₁ is greater than L₂, and the third portion is cooler than the first portion which is cooler than the second portion.

8. The combustor of claim 7, wherein the at least one first turbulator sub-group is axially spaced from the at least one second turbulator sub-group by an axial distance S₁, and the at least one second turbulator sub-group is axially spaced from the at least one third turbulator sub-group by an axial distance S₂, and wherein S₁ is less than S₂.

9. The combustor of claim 8, wherein at least some of the individual turbulators in the at least one first turbulator sub-group have a height of H₁, at least some of the individual turbulators in the at least one second turbulator sub-group have a height of H₂, and at least some of the individual turbulators in the at least one third turbulator sub-group have a height of H₃, and wherein H₃ is less than H₁ which is less than H₂.

10. A combustor for a turbine, the combustor having a plurality of fuel nozzles and a combustion zone aligned with a combustion process associated with each of the plurality of fuel nozzles, the combustor comprising:
a combustion liner comprising a plurality of turbulator groups, each of the plurality of turbulator groups comprising one or more individual turbulators, each of the plurality of turbulator groups substantially aligned with a hot streak in the combustion liner caused by the combustion zone associated with one of the plurality of fuel nozzles; and
wherein each of the plurality of turbulator groups are circumferentially spaced from a neighboring turbulator group.

11. The combustor of claim 10, wherein an axial spacing between at least some of the one or more individual turbulators in at least one of the plurality of turbulator groups is varied.

12. The combustor of claim 11, wherein the axial spacing between at least some of the one or more individual turbulators is smaller in a hotter portion of the hot streak, and the axial spacing between at least some of the one or more individual turbulators is larger in a cooler portion of the hot streak.

13. The combustor of claim 10, wherein each of the plurality of turbulator groups comprises multiple turbulator sub-groups.

14. The combustor of claim 13, wherein the multiple turbulator sub-groups further comprise:
at least one first turbulator sub-group having an axial spacing of L₁ between at least some adjacent individual turbulators, the at least one first turbulator sub-group located in a first portion of the hot streak;
at least one second turbulator sub-group having an axial spacing of L₂ between at least some adjacent individual turbulators, the at least one second turbulator sub-group located in a second portion of the hot streak;
wherein L₁ is greater than L₂, and the first portion of the hot streak is cooler than the second portion of the hot streak.

15. The combustor of claim 14, wherein at least some of the individual turbulators in the at least one first turbulator sub-group have a height of H₁, and at least some of the individual turbulators in the at least one second turbulator sub-group have a height of H₂, and wherein H₁ is less than H₂.

16. The combustor of claim 14, further comprising:
at least one third turbulator sub-group having an axial spacing of L₃ between at least some adjacent individual turbulators, the at least one third turbulator sub-group located in a third portion of the hot streak,
wherein L₃ is greater than L₁, and L₁ is greater than L₂, and the third portion of the hot streak is cooler than the first portion of the hot streak which is cooler than the second portion of the hot streak.

17. The combustor of claim 16, wherein the at least one first turbulator sub-group is axially spaced from the at least one second turbulator sub-group by an axial distance S₁, and the at least one second turbulator sub-group is axially spaced from the at least one third turbulator sub-group by an axial distance S₂, and wherein S₁ is less than S₂.

18. The combustor of claim 17, wherein at least some of the individual turbulators in the at least one first turbulator sub-group have a height of H₁, at least some of the individual turbulators in the at least one second turbulator sub-group have a height of H₂, and at least some of the individual turbulators in the at least one third turbulator sub-group have a height of H₃, and wherein H₃ is less than H₁ which is less than H₂.
